(19) United States
(12) Patent Application Publication
(10) Pub. No.: US 2016/0054705 A1
(43) Pub. Date: Feb. 25, 2016

(54) TIMEPIECE COMPRISING A CHIMING DEVICE

(71) Applicants: Michael FELDBAUSCH, Carouge (CH); Cedric JOHNER, Thonex (CH); Giulio PAPI, La Chaux-de-Fonds (CH)

(72) Inventors: Michael FELDBAUSCH, Carouge (CH); Cedric JOHNER, Thonex (CH); Giulio PAPI, La Chaux-de-Fonds (CH)

(21) Appl. No.: 14/783,831

(22) PCT Filed: Apr. 8, 2014
(86) PCT No.: PCT/IB2014/000509

§ 371 Date: Oct. 21, 2015

(30) Foreign Application Priority Data
Apr. 11, 2013 (CH) CH00753/13

(51) Int. Cl. G04B 21/04; G04B 21/08; G04B 21/06

(52) U.S. Cl. CPC G04B 21/04; G04B 21/06; G04B 21/08

(57) ABSTRACT

A timepiece comprises a chiming device including at least one pivoting toothed sector called rack (1) intended to cooperate with at least one first part (2), driving a second part (3) secured to a pin (32) cooperating with an eccentric (41) for actuating at least one hammer (4) characterized in that the hammer (4) chimes a gong (5) extending substantially in a plane A by being displaced along a plane B which intercepts the plane A of the gong (5).

The present invention relates to a timepiece including a mechanical chiming device.

It is already known from the state of the technique chiming mechanisms, in particular minute repeating, for mechanical watches. Particularly, it is worth noting that such a standard timepiece includes a movement and a chiming mechanism to chime current time quarters by two different sounds. The chiming mechanism comprises:
a source of energy,
a snail driven by the movement to provide information about the current time quarters,
a feeler-spindle for cooperating with this snail to gather information on the current time quarters, a first and a second pallet for respectively actuating a first and a second hammer intended to respectively chime a first and a second gong.

In this conventional embodiment, the hammers pivot in a plane which is parallel with the plane of the gong, thus, in particular for a space gain in terms of watch thickness.

EP2290479 describes a watch including a chiming device comprising a gong having a bar surrounding a movement and extending substantially in a plane, a gong-carrier secured to a frame of the watch, the gong being secured on the gong-carrier, at least a hammer for chiming the gong so as to produce a vibration of said gong, characterized in that the hammer is arranged to come and chime an impact surface of the gong which is slanting with respect to the horizontal to said plane. Contrary to the present invention, the impact direction in other words the direction of the hammer movement, is parallel to the plane of the gong.

The purpose of the present invention is to create timepieces including an innovative mechanical chiming device with a powerful aesthetic effect.

In accordance with the invention, a timepiece comprises a chiming device including at least one rack intended to cooperate with at least one first part, driving a second part secured to a pin cooperating with a third part, secured to a hammer, for actuating at least one hammer, the hammer then chiming a gong extending substantially in a plane A by being displaced along a plane B different from the plane A of the gong.

Such a chiming device may be used for any type of chiming work, such as for example a chiming work for the hours, a chiming work for the minutes, a chiming work for the quarters and thus, whatever the considered configuration (chiming work in passing, upon request, . . . ) or for a melody.

The features of the invention will appear more clearly upon reading several embodiments given only by way of example, in no way limiting and with reference to the schematic figures, in which:

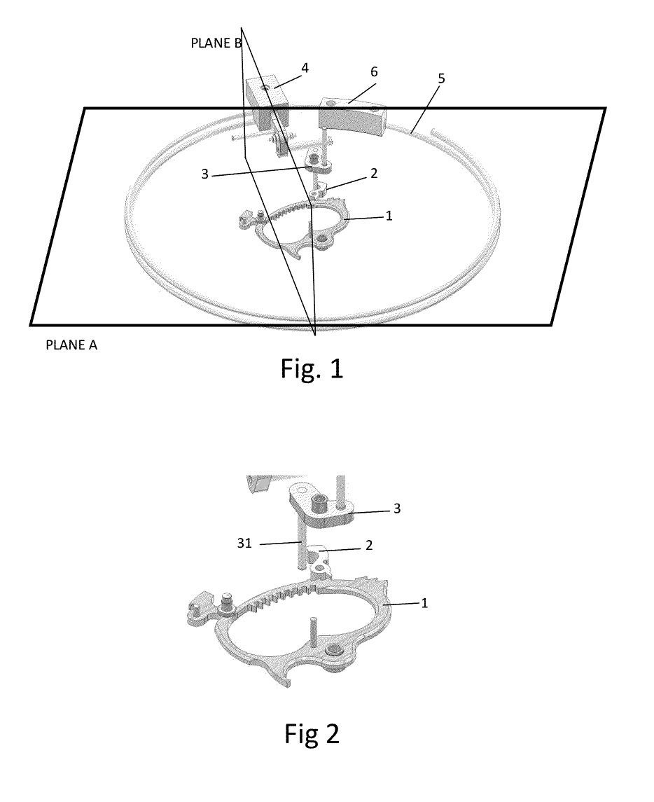

FIG. 1 represents a perspective view of the main elements of the chiming device according to the invention;

FIG. 2 represents a perspective view of the quarter-rack, driving the quarter chime gathering pallet bringing the reverser pallet;

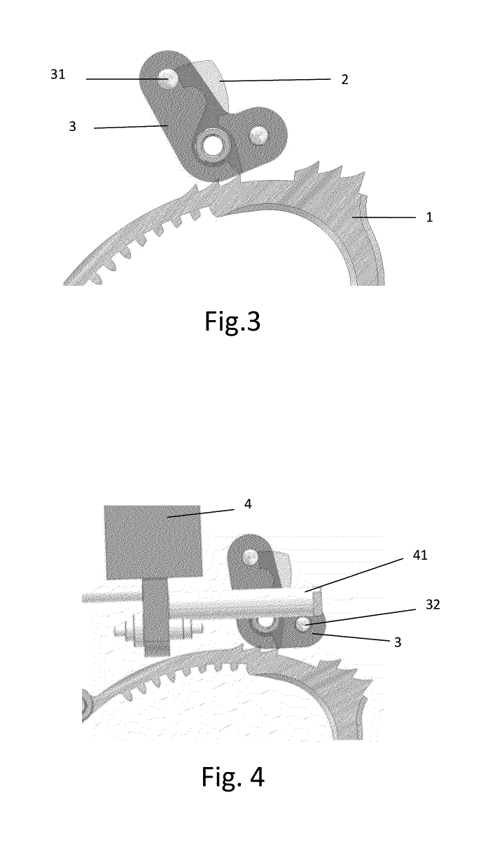

FIG. 3 is a top view of the quarter chime gathering pallet, and of the reverser pallet;

FIG. 4 is a top view of a pin, driving the hammer by means of the eccentric;

FIG. 5 represents a perspective view of a hammer chiming a gong according to the invention;

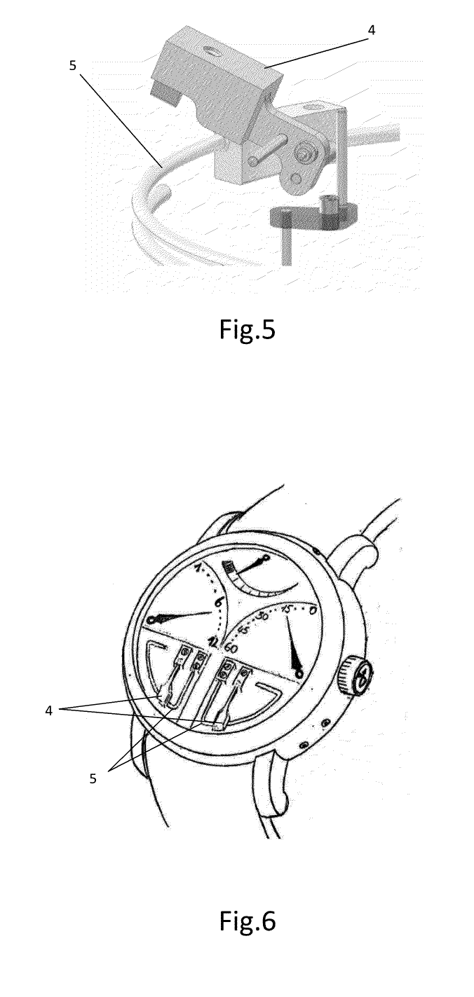

FIG. 6 represents a perspective view of a wrist-watch including two hammers disposed in parallel with each other;

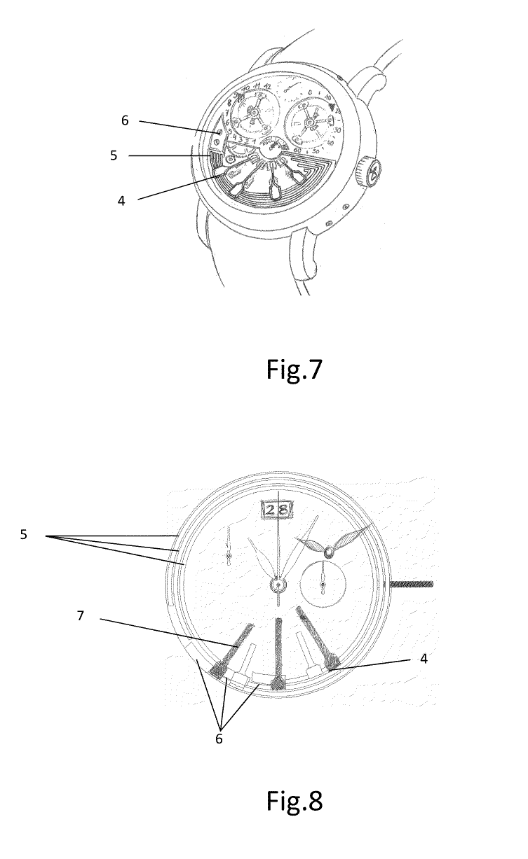

FIG. 7 represents a perspective view of a wrist-watch including several hammers; and

FIG. 8 represents a partial front view of a wrist-watch including several hammers coming to chime several gongs disposed on the circumference of the wrist-watch.

The following description, relates to a chiming mechanism for chiming the quarters, and it is given by way of example and serves as support for the present invention.

According to an embodiment of the invention, illustrated on FIG. 1, the wrist-watch comprises a chiming device including a quarter-rack 1, a quarter chime gathering pallet 2, a reverser pallet 3, a hammer 4 and a gong 5. In the rest of the description, the plane of the gong 5 will be called plane A and the plane in which the hammer 4 is displaced, plane B.

As illustrated on FIG. 2, at least one pivoting rack 1 is intended to cooperate with at least one first part 2, called quarter chime gathering pallet.

The quarter chime gathering pallet 2 drives a second part 3, called reverser pallet and is secured to a pin 32 cooperating with a third part 41, secured to the hammer 4, to actuate at least one hammer 4 (FIG. 4). This third part 41 may for example be a pin or an eccentric as illustrated in FIG. 4.

The hammer 4 chimes a gong 5 extending substantially in a plane A by being displaced along a plane B which intercepts the plane A of the gong 5.

As visibly illustrated, in particular on FIG. 3, the rack 1 is a quarter-rack including a first and a second set of three teeth.

According to this embodiment, the quarter chime gathering pallet 2 and the reverser pallet 3 are coaxial (FIG. 3).

The hammer 4 chimes the gong 5 by being displaced, preferably, according to a direction which is perpendicular with respect to plane A of said gong 5 (FIG. 5).

In a variant, the hammer 4 chimes the gong 5 by being displaced along a slanting plane, the main condition being that the plane A, plane of said gong, and the plane B are intercepted.

As illustrated on FIG. 6, a wrist-watch includes two hammers 4 disposed parallel with each other, each hammer 4 coming to vertically chime a very distinct gong 5. The two gongs 5 are of the same length but in a variant, they can be of different length and secured to one or several gong-carriers 6.

In another embodiment, illustrated on FIG. 7, several hammers 4 are distributed along radial directions around a geometrical center of the timepiece. In this embodiment, there are distinguished for example four hammers 4 which come to vertically chime four gongs 5. The four gongs 5 are secured at one of their ends to the same gong-carrier 6, opposite to FIG. 6 in which each gong 5 is secured by one of its ends to a different gong-carrier 6.

As illustrated on FIG. 8, a plurality of gongs 5 are disposed on the circumference of the timepiece and radially spaced apart from each other. Each gong 5 corresponds to a hammer 4 which extends to this gong 5. The hammers 4 may be of the same length or of different length as is the case in the illustrated example.

A simple variant is to provide a wrist-watch including such a chiming device in which one single hammer 4 would chime one single gong 5.

Each hammer 4 is constituted of a stem 7, said hammer 4 pivoting according to an axis of rotation located either at the free end of the stem 7 as illustrated for example on FIG. 5, or at an intermediate point of the length of the stem 7.

Based on the description which has just been made, several variants of the chiming mechanism of a timepiece provided with a hammer 4 may be considered, for example, by being displaced according to a plane different from the plane of the gong 5 on which the hammer 4 chimes.

1. A timepiece comprising a chiming device including at least one pivoting toothed sector called rack (1) intended to cooperate with at least one first part (2), driving a second part (3) secured to a pin (32) cooperating with a third part (41) for actuating at least one hammer (4) characterized in that the hammer (4) chimes a gong (5) extending substantially in a plane A by being displaced along a plane B which intercepts the plane A of the gong (5).

2. The timepiece comprising a chiming device according to claim 1, wherein the rack (1) is a quarter-rack including a first and a second set of teeth.

3. The timepiece comprising a chiming device according to claim 1, wherein the first part (2) is a part called quarter chime gathering pallet.

4. A timepiece comprising a chiming device according to claim 3, wherein another pin (31) secured to the second part (3) is driven by the quarter chime gathering pallet (2).

5. A timepiece comprising a chiming device according to claim 4, wherein the second part (3) is a part called reverser pallet.

6. A timepiece comprising a chiming device according to claim 5, wherein the quarter chime gathering pallet (2) and the reverser pallet (3) are coaxial.

7. A timepiece comprising a chiming device according to claim 1, wherein the hammer (4) chimes the gong (5) by being displaced along a direction which is perpendicular with respect to plane A of said gong (5).

8. A timepiece comprising a chiming device according to claim 1, including a hammer (4) constituted of a stem (7), said hammer (4) pivoting along an axis of rotation located either at the free end of the stem (7) or at an intermediate point of the length of the stem (7).

9. A timepiece comprising a chiming device according to claim 1, including a hammer (4).

10. A timepiece comprising a chiming device according to claim 1, including at least two hammers (4) disposed parallel to each other.

11. A timepiece comprising a chiming device according to claim 1, including at least two hammers (4) distributed along substantially radial directions around a geometrical center of the timepiece.

12. A timepiece comprising a chiming device according to claim 1, including a plurality of gongs (5) disposed at the circumference of the timepiece and radially spaced apart from each other, said each gong (5) corresponding to a hammer (4) which extends to this gong (5).
